(19) United States
(12) Patent Application Publication
(10) Pub. No.: US 2015/0199688 A1
(43) Pub. Date: Jul. 16, 2015

(54) System and Method for Analyzing an Alert

(71) Applicant: Bank of America Corporation, Charlotte, NC (US)

(72) Inventors: Subramanian Selvaraj Sulur, Charlotte, NC (US); Wan Lung Alvin Lee, Charlotte, NC (US); Alpesh Rajnikant Shah, Marvin, NC (US); Carl Suplee, Huntersville, NC (US)

(73) Assignee: Bank of America Corporation, Charlotte, NC (US)

(21) Appl. No.: 14/156,045

(22) Filed: Jan. 15, 2014

(51) Int. Cl. G06Q 20/40

(52) U.S. Cl. CPC G06Q 20/4016

(57) ABSTRACT

According to one embodiment, a method comprises receiving an alert indicating one or more financial transactions associated with potentially suspicious activity. The method performs a validation of the alert, the validation comprising: determining that the alert comprises sufficient detail; determining whether the alert corresponds to an overlapping alert; and determining that the potentially suspicious activity corresponds to a potential risk. In response to a determination that the alert corresponds to an overlapping alert, the method consolidates the alert and the overlapping alert. The alert is associated with a customer profile. Alert data and customer information associated with the customer profile are enriched to yield an enriched alert. An event is created and communicated if the enriched alert satisfies an event-worthiness test.

### TECHNICAL FIELD

The present invention relates generally to financial services and more specifically to a system and method for analyzing an alert.

### BACKGROUND

Banks and other financial institutions use financial crimes compliance detection channels to detect potential suspicious activity related to money laundering and other financial crimes, such as economic sanction violations and fraudulent activities. Financial institutions receive alerts from single or multiple detection channels that target specific types of clients, accounts, transaction activities, and risks. The alerts are used to create events and the events trigger various investigative processes depending on the event type. Currently, an event is created for each alert generated by a detection channel and no system intelligence exists to analyze an alert on its own. This results in more complex cases and inconsistencies between alerts generated by different detection channels.

### SUMMARY OF EXAMPLE EMBODIMENTS

In accordance with the present invention, disadvantages and problems associated with monitoring suspicious financial activities may be reduced or eliminated.

According to one embodiment of the present invention, a method comprises receiving an alert indicating one or more financial transactions associated with potentially suspicious activity. The method performs a validation of the alert, the validation comprising: determining that the alert comprises sufficient detail; determining whether the alert corresponds to an overlapping alert; and determining that the potentially suspicious activity corresponds to a potential risk. In response to a determination that the alert corresponds to an overlapping alert, the method consolidates the alert and the overlapping alert. The alert is associated with a customer profile. Alert data and customer information associated with the customer profile are enriched to yield an enriched alert. An event is created and communicated if the enriched alert satisfies an event-worthiness test.

Certain embodiments of the invention may provide one or more technical advantages. Technical advantages of one embodiment include validating and enriching an alert to determine whether to create an event for investigative analysis. Validating the alert prevents generating an event for an incomplete, duplicate, or overlapping alert. Enriching the alert adds to the alert data selected to provide a comprehensive view of the alert. The selected data may include alert data and some or all of the customer information associated with the customer profile. Another technical advantage includes communicating the alert to an incomplete queue if the alert is not validated, and allowing the incomplete queue to automatically update the alert or an administrator to manually add details or make decisions concerning the alert. Another technical advantage of an embodiment includes creating multiple events from a single alert to simplify cases. The cases are simplified by creating events that only include alert data and customer information associated with a customer profile that is relevant to the event analysis teams and/or systems within a specific jurisdiction. Yet another technical advantage of an embodiment removes inconsistencies between alerts generated by different detection channels by transforming alerts into a standard event interface.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 illustrates an example of a system that analyzes an alert;

FIG. 2A illustrates an example of a database record that stores alert data;

FIG. 2B illustrates an example of a database record that stores a customer profile; and

FIG. 3 illustrates a flowchart for validating and enriching an alert to generate an event.

### DETAILED DESCRIPTION

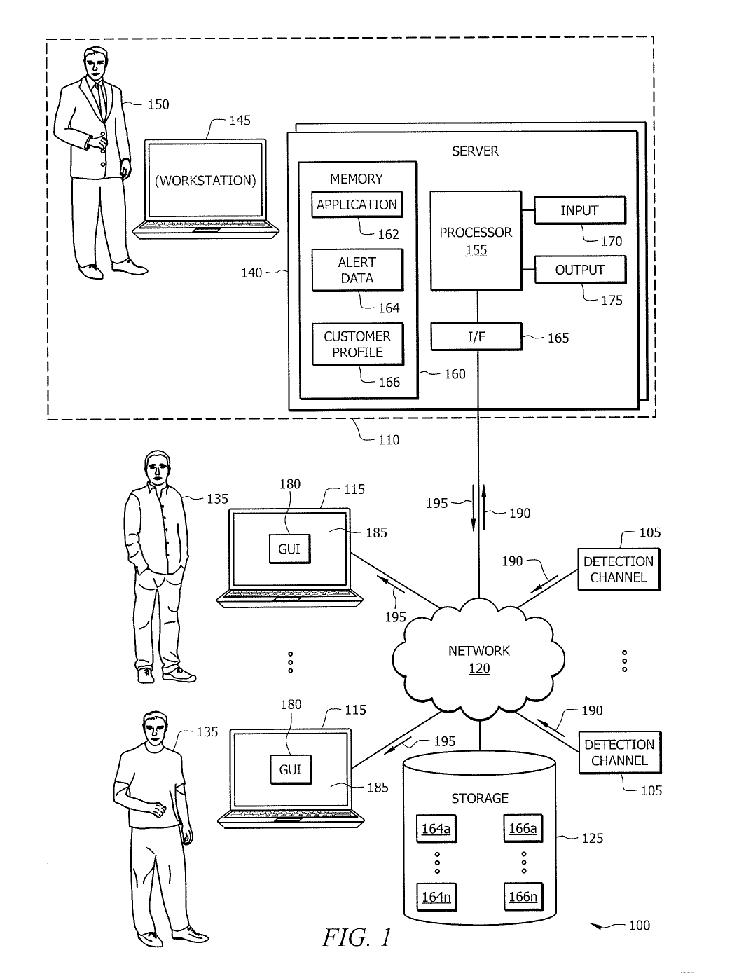

Embodiments of the present invention and its advantages are best understood by referring to FIGS. 1 through 3 of the drawings, like numerals being used for like and corresponding parts of the various drawings.

Banks and other financial institutions use financial crimes compliance detection channels to detect potential suspicious activity related to money laundering and other financial crimes, such as economic sanction violations and fraudulent activities. Financial institutions receive alerts from single or multiple detection channels that target specific types of clients, accounts, transaction activities, and risks. The alerts are used to create events and the events trigger various investigative processes depending on the event type. Currently, an event is created for each alert generated by a detection channel and no system intelligence exists to analyze an alert on its own. This results in more complex cases and inconsistencies between alerts generated by different detection channels. The teachings of this disclosure recognize that it would be desirable to enrich alerts before events are created, providing flexibility to generate and monitor events relevant to the type of investigative process to follow, and format alerts to fit a standard event interface for the consumption of downstream applications. FIGS. 1 through 3 below illustrate a system and method of enriching alerts and transforming alerts into a standard event interface.

FIG. 1 illustrates a system 100 according to certain embodiments. System 100 may include one or more detection channels 105, an enterprise 110, one or more clients 115, a network storage device 125, one or more users 135, and one or more servers 140. Detection channels 105, enterprise 110, clients 115, and network storage device 125 may be communicatively coupled by a network 120. Enterprise 110 is generally operable to provide an event 195, as described below.

In general, one or more servers 140 may provide one or more events 195 to users 135. Server 140 may first receive an alert 190 from detection channel 105. Detection channel 105 may refer to any system, process, or tool that generates and communicates alert 190 to server 140. It will be understood that system 100 may comprise any number and combination of detection channels 105.

In response to receiving alert 190 from detection channel 105, server 140 may determine that alert 190 indicates one or more financial transactions associated with potentially suspicious activity. Examples of potentially suspicious activity may include cash structuring, depositing large amounts of cash into an account, high-amount transactions or fund transfers inconsistent with a customer's transaction history or income, or multiple wires to multiple people on the same day with corresponding dollar amounts. In general, server 140 validates and enriches alert 190 to generate event 195, and then communicates event 195 to users 135.

In some embodiments, server 140 validates alert 190 based on alert data 164. Validating alert 190 may include determining that alert data 164 provides sufficient information to generate event 195 based on a series of validation rules. Alert data 164 may include a party or customer identifier (for example, a customer name, account number, or social security number), one or more transactions associated with potentially suspicious activity, a date and type corresponding to the one or more transactions, or a detailed description of alert 190.

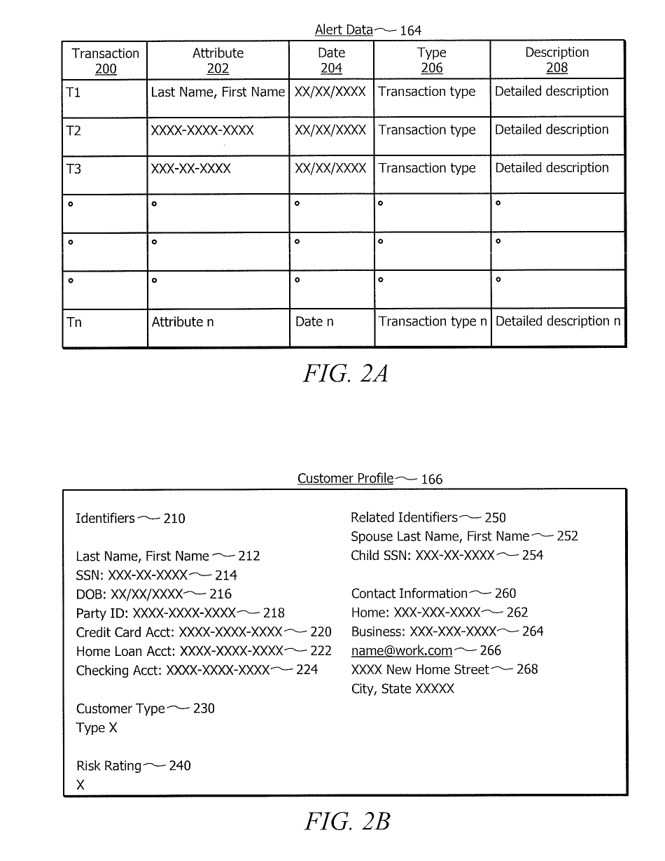

In some embodiments, server 140 enriches alert 190 based on customer profile 166. Customer profile 166 may comprise any information associated with a customer that may be stored in one or more records in one or more databases. Customer may refer to a direct customer or a third-party customer (customer of a customer). For example, a large bank may have a small bank as a customer and small bank may have an individual as a customer, and the individual may conduct transactions that use the large bank's infrastructure. Customer information in customer profile 166 may include a customer identifier (for example, a name, social security number, or date of birth), party identifier (for example, global identifier across multiple accounts, like checking, savings, and loan), account number (for example, a credit card account, home loan account, or checking account), jurisdiction (where the account is domiciled), risk rating (for example, based on customer history, account balance, and type of potentially suspicious activity), or customer type (for example, individual, large business, or small business). In some embodiments, customer profile 166 may include a related party identifier associated with members of the customer's household, such as the customer's spouse, children, and/or parents. Example embodiments of alert data 164 and customer profile 166 are described in FIG. 2 below.

In the illustrated embodiment, network storage device 125 stores alert data 164 and customer profile 166. Network storage device 125 may refer to any suitable device communicatively coupled to network 120 and capable of storing and facilitating retrieval of data and/or instructions. Examples of network storage device 125 include computer memory (for example, Random Access Memory (RAM) or Read Only Memory (ROM)), removable storage media (for example, a Compact Disk (CD) or a Digital Video Disk (DVD)), database and/or network storage (for example, a server), and/or any other volatile or non-volatile, non-transitory computer-readable memory devices that store one or more files, lists, tables, or other arrangements of information. Network storage device 125 may store any data and/or instructions utilized by server 140.

Detection channels 105, servers 140, and other components of system 100 may be communicatively coupled by network 120. In certain embodiments, network 120 may refer to any interconnecting system capable of transmitting audio, video, signals, data, messages or any combination of the preceding. Network 120 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, enterprise 110 may refer to a financial institution such as a bank and may include one or more servers 140, an administrator workstation 145, and an administrator 150. In some embodiments, server 140 may refer to any suitable combination of hardware and/or software implemented in one or more modules to process data and provide the described functions and operations. In some embodiments, the functions and operations described herein may be performed by a pool of servers 140. In some embodiments, server 140 may include, for example, a mainframe, server, host computer, workstation, web server, file server, a personal computer such as a laptop, or any other suitable device operable to process data. In some embodiments, server 140 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems.

In general, server 140 validates and enriches alert 190 to generate event 195, and then communicates event 195 to users 135. In some embodiments, server 140 may include a processor 155, server memory 160, an interface 165, an input 170, and an output 175. Server memory 160 may refer to any suitable device capable of storing and facilitating retrieval of data and/or instructions. Examples of server memory 160 include computer memory (for example, RAM or ROM), mass storage media (for example, a hard disk), removable storage media (for example, a CD or a DVD), database and/or network storage (for example, a server), and/or any other volatile or non-volatile, non-transitory computer-readable memory devices that store one or more files, lists, tables, or other arrangements of information. Although FIG. 1 illustrates server memory 160 as internal to server 140, it should be understood that server memory 160 may be internal or external to server 140, depending on particular implementations. Also, server memory 160 may be separate from or integral to other memory devices to achieve any suitable arrangement of memory devices for use in system 100.

Server memory 160 is generally operable to store an application 162, alert data 164, and customer profile 166. Application 162 generally refers to logic, rules, algorithms, code, tables, and/or other suitable instructions for performing the described functions and operations. In some embodiments, application 162 facilitates validating, associating, and enriching alert 190 to generate event 195 and communicate event 195 to users 135.

Server memory 160 communicatively couples to processor 155. Processor 155 is generally operable to execute application 162 stored in server memory 160 to generate and communicate event 195 according to the disclosure. Processor 155 may comprise any suitable combination of hardware and software implemented in one or more modules to execute instructions and manipulate data to perform the described functions for servers 140. In some embodiments, processor 155 may include, for example, one or more computers, one or more central processing units (CPUs), one or more microprocessors, one or more applications, and/or other logic.

In some embodiments, communication interface 165 (I/F) is communicatively coupled to processor 155 and may refer to any suitable device operable to receive input for server 140, send output from server 140, perform suitable processing of the input or output or both, communicate to other devices, or any combination of the preceding. Communication interface 165 may include appropriate hardware (e.g., modem, network interface card, etc.) and software, including protocol conversion and data processing capabilities, to communicate through network 120 or another communication system, which allows server 140 to communicate to other devices. Communication interface 165 may include any suitable software operable to access data from various devices such as clients 115 and/or network storage device 125. Communication interface 165 may also include any suitable software operable to transmit data to various devices such as clients 115 and/or network storage device 125. Communication interface 165 may include one or more ports, conversion software, or both. In general, communication interface 165 receives alert 190 from detection channel 105 and transmits event 195 to client 115.

In some embodiments, input device 170 may refer to any suitable device operable to input, select, and/or manipulate various data and information. Input device 170 may include, for example, a keyboard, mouse, graphics tablet, joystick, light pen, microphone, scanner, or other suitable input device. Output device 175 may refer to any suitable device operable for displaying information to a user. Output device 175 may include, for example, a video display, a printer, a plotter, or other suitable output device.

In general, administrator 150 may interact with server 140 using an administrator workstation 145. In some embodiments, administrator workstation 145 may be communicatively coupled to server 140 and may refer to any suitable computing system, workstation, personal computer such as a laptop, or any other device operable to process data. In certain embodiments, administrator 150 may utilize administrator workstation 145 to manage server 140 and any of the data stored in server memory 160 and/or network storage device 125.

In operation, application 162, upon execution by processor 155, facilitates validating, associating, and enriching alert 190 to generate event 195, and communicates event 195 to users 135. To provide event 195, application 162 may first receive alert 190 from detection channel 105. Alert 190 may include one or more attributes indicating a customer associated with the one or more financial transactions. Examples of attributes include customer name, social security number, date of birth, unique party identifier (e.g., an identifier assigned by the enterprise to identify all the accounts associated with the customer), account number, and so on.

Once application 162 receives alert 190, application 162 performs a validation of alert 190. In some embodiments, application 162 determines whether alert 190 comprises sufficient detail to generate event 195 based on a series of validation rules. Checking for sufficient detail can include a completeness verification and/or a not-ready step.

A completeness verification may confirm whether alert 190 includes sufficient information to generate event 195. For example, an alert 190 may fail the completeness verification if the alert only comprises a location, dollar amount, and date, but does not include sufficient information to correlate the alert to a particular customer. Thus, alert 190 will need to be updated to further comprise a customer name, account number, or other suitable identifier before event 195 may be generated. In some embodiments, application 162 may flag alert 190 as incomplete in response to determining that alert 190 does not comprise sufficient information to generate event 195.

A not-ready step may determine alert 190 is not ready for downstream event processing based on specified alert attributes. As an example, application 162 may determine alert 190 is not ready for downstream event processing in response to receiving an attribute indicating a not-ready flag. As another example, application 162 may determine alert 190 is not ready for downstream event processing based on an attribute indicating the type of alert. That is, certain alerts 190 may be assigned to a type category used for piloting, debugging, testing, or other administrative purpose that may not require sending the alert 190 to downstream processes. In certain embodiments, application 162 may flag alert 190 if alert 190 is not ready for downstream processing and is not already flagged.

In some embodiments, if alert 190 does not comprise sufficient detail to generate event 195, application 162 may communicate alert 190 to a queue, such as an incomplete queue. The queue can automatically update alert 190 and send it back through validation or it can allow administrator 150 to manually add details or make decisions concerning alert 190 (e.g., manually repair, update, or validate alert 190).

As another example, application 162 may determine whether alert 190 corresponds to an overlapping alert based on the one or more financial transactions indicated by alert 190. A check for an overlapping alert can include a duplicate check (e.g., total overlap) or a partial overlap (such as when Transaction 1 triggers an alert based on dollar amount and Transaction 1 also triggers an overlapping alert based on location). If alert 190 corresponds to an overlapping alert, application 162 flags alert 190 and/or consolidates alert 190 and the overlapping alert.

In some embodiments, application 162 may determine whether the potentially suspicious activity associated with one or more transactions indicated by alert 190 corresponds to a potential risk by performing a no-risk check. For example, if alert 190 indicates one or more financial transactions associated with a general ledger or concentration account used to move funds within, for example, an organization or business, but does not indicate specific customer activity being monitored by detection channels 105, alert 190 may not correspond to a potential risk. If application 162 determines that alert 190 does not pose a risk, application 162 may communicate alert 190 to a queue and/or mark alert 190 as a no-risk alert.

In some embodiments, application 162 may associate alert 190 with customer profile 166 based on an attribute (e.g., an identifier associated with the customer that identifies the customer) of the one or more financial transactions indicated by alert 190. An attribute of a financial transaction can be a name, personal account number, business account number, and so on. In some embodiments, an attribute may be an identifier associated with members of the customer's household, such as a name or account number of the customer's spouse, children, and/or parents. Another attribute could be a unique party identifier. The party identifier may refer to a unique identifier assigned by the financial institution to identify the accounts that are to be included in customer profile 166. For example, the party identifier may be used to identify all of the accounts associated with the customer.

Once application 162 associates alert 190 with customer profile 166, application 162 may enrich alert 190 and customer information associated with customer profile 166 to yield an enriched alert. An enriched alert refers to data selected to provide a comprehensive view of alert 190 and may include alert data 164 and some or all of the customer information associated with customer profile 166. In some embodiments, application 162 can determine to enrich alert 190 using additional data, such as any additional data associated with the customer or the one or more financial transactions, stored in any database of server memory 160 and/or network storage device 125. In some embodiments, yielding the enriched alert can include combining alert 190 and customer information associated with customer profile 166. Yielding the enriched alert can also include determining the type of alert, determining standard information recommended for that type of alert, determining if alert 190 contains the recommended information, and adding any of the customer's information 166 that corresponds to the recommended information if it is not already in alert 190.

Examples of customer information that application 162 may add to alert 190 include a unique party identifier (for example, global identifier across multiple accounts, like checking, savings, and loan), a driver's license number, primary contact information (for example, home address, business address, or related party's address), personal account number and/or business account number, jurisdiction (where each account associated with the customer is domiciled), risk rating (for example, based on customer history, account balance, and type of potentially suspicious activity), or customer type (for example, individual, large business, or small business). In some embodiments, customer information added to alert 190 may also include a related party identifier associated with members of the customer's household, such as the customer's spouse, children, and/or parents. Moreover, enriching alert 190 can include associating alert 190 with an alert type, determining standardized fields for the alert type, and populating the standardized fields based on customer information in customer profile 166.

In some embodiments, application 162 may further enrich alert 190 by associating one or more related parties with alert 190. Examples of related parties include the customer itself, a member of the customer's household, or another related party. In some embodiments, application 162 may also associate the one or more related parties with a second alert and then group alert 190 and the second alert in an alert group. The second alert may indicate another potentially suspicious transaction by the same customer or by a member of the customer's household. For example, alert 190 may indicate cash structuring transactions by the customer and the second alert may indicate large cash deposits by the customer's spouse.

After enriching alert 190, application 162 may determine to create event 195 if the enriched alert satisfies an event-worthiness test. For example, the event-worthiness test may include processing the enriched alert to determine whether the customer is an individual, a small business, or a large business, and whether the customer typically makes the type of financial transactions indicated by alert 190. As an example, application 162 may determine that a large wire transfer is not event-worthy if it is made by a large company that typically makes large wire transfers. Alternatively, application 162 may determine that a large wire transfer is event-worthy if it is made by an individual customer that does not typically make large wire transfers. Once application 162 determines that the enriched alert is event-worthy, application 162 creates event 195.

In some embodiments, application 162 may associate a related party with event 195, associate the related party with a second event, and then group event 195 and the second event in an event group. The related party can be the customer itself, a member of the customer's household, or another related party. Additionally, a second event could be another potentially suspicious transaction by the same customer or by a member of the customer's household. For example, event 195 may be cash structuring transactions by the customer and a second event may be large cash deposits by the customer's spouse. Application 162 may group event 195 and the second event in an event group, and may communicate the event group in any suitable format, as described below.

Alternatively, application 162 may determine alert 190 indicates a first transaction associated with a first jurisdiction and a second transaction associated with a second jurisdiction, and in response create a first event corresponding to the first jurisdiction and a second event corresponding to the second jurisdiction. Application 162 may determine the first jurisdiction and the second jurisdiction through list-based logic. In some embodiments, the jurisdiction information may be maintained with alert 190 and leveraged for downstream usage (i.e., event routing). An advantage of this embodiment would be simplified cases by creating events 195 that only include alert data 164 and customer information associated with customer profile 166 relevant to event analysis teams and/or systems within a specific jurisdiction.

In some embodiments, application 162 may determine to open a case if a risk-level causes a customer associated with event 195 to exceed a risk-points threshold. For example, application 162 may process event 195 according to a risk-determination rule to determine how many risk points to assign to event 195. Application 162 may also determine how many risk points to assign to each event 195 in an event group, if any. If the number of risk points exceed a predetermined threshold, a case may be generated. For example, the risk-determination rule may include assigning 2 points for cash structuring, 3 points for depositing large amounts of cash into an account, 5 points for multiple wires to multiple people on the same day with corresponding dollar amounts, and so on. Further, the risk-determination rule may assign a risk-points threshold of 5 points. Thus, application 162 may determine not to open a case for a single instance of cash structuring because the point value (2) is less than the risk-points threshold (5). By contrast, application 162 may open a case if event 195 and/or the event group includes an instance of depositing a large amount of cash into an account and an instance of multiple wires to multiple people on the same day with corresponding dollar amounts because the point values (3 and 5) collectively exceed the risk-points threshold (5+3>5).

Application 162 communicates event 195 and/or the event group in any suitable format. In some embodiments, event 195 can have a standardized format comprising standardized fields. For example, if a customer is an individual, the standardized fields may include a household identifier. But if the customer is a business, the standardized fields would not include a household identifier. Moreover, event 195 may be communicated to a display or other user interface, or it can be communicated to any downstream application (e.g., an event processor or any other suitable system). For example, one or more servers 140 may provide event 195 to user 135 by utilizing client 115. Client 115 may refer to any device that enables user 135 to interact with server 140. In some embodiments, client 115 may include a computer, workstation, telephone, Internet browser, electronic notebook, Personal Digital Assistant (PDA), pager, or any other suitable device (wireless, wireline, or otherwise), component, or element capable of receiving, processing, storing, and/or communicating information with other components of system 100. Client 115 may also comprise any suitable user interface such as a display 185, microphone, keyboard, or any other appropriate terminal equipment usable by user 135. It will be understood that system 100 may comprise any number and combination of clients 115 or users 135. User 135 may utilize client 115 to interact with server 140 to receive event 195. In some embodiments, user 135 may be a financial institution employee conducting an investigative analysis of the one or more financial transactions associated with potentially suspicious activity indicated by alert 190.

In some embodiments, client 115 may include a graphical user interface (GUI) 180. GUI 180 is generally operable to tailor and filter data presented to user 135. GUI 180 may provide user 135 with an efficient and user-friendly presentation of event 195. GUI 180 may comprise a plurality of displays having interactive fields, pull-down lists, and buttons operated by user 135. GUI 180 may include multiple levels of abstraction including groupings and boundaries. It should be understood that the term GUI 180 may be used in the singular or in the plural to describe one or more GUIs 180 and each of the displays of a particular GUI 180.

FIGS. 2A and 2B illustrate examples of database records that may be stored in server memory 160. In some embodiments, the database stores alert data 164 and/or client profile 166. Alert data 164 may include multiple alert data records, such as one or more of alert data 164a to 164n of network storage device 125. Customer profiles 166 stored in server memory 160 may include multiple customer profile records, such as one or more of customer profile 166a to 166n of network storage device 125. Server memory 160 may store the data in any suitable format.

FIG. 2A illustrates alert data 164 that may be stored in the database. Examples of alert data 164 include transactions 200, attributes 202, transaction dates 204, transaction types 206, and/or detailed descriptions 208 of transactions 200. For each transaction 200, the database may store one or more attributes 202 of transaction 200. Attributes 202 may include any identifier associated with the customer that identifies the customer. For example, attribute 202 can be a name, personal account number, business account number, social security number and so on. In some embodiments, attribute 202 may be an identifier associated with members of the customer's household, such as a name or account number of the customer's spouse, children, and/or parents. Attribute 202 may also be a unique party identifier. The party identifier may refer to a unique identifier assigned by the financial institution to identify the accounts that are to be included in customer profile 166. For example, the party identifier may be used to identify all of the accounts associated with the customer.

For each transaction 200, the database may also store a transaction date 204 (e.g., the date the transaction occurred), transaction type 206 (e.g., cash structuring, high-amount cash deposits, foreign wire transactions, etc.), and detailed description 208 (e.g., describing the reason for generating an alert). In some embodiments, description 208 may include a location (e.g., the location where the transaction occurred, account is domiciled, customer resides, etc.), dollar amount, or summary of the potentially suspicious activity. For example, the summary of the potentially suspicious activity may describe cash structuring, large cash deposits, high-amount transactions or fund transfers inconsistent with a customer's transaction history or income, or multiple wires to multiple people on the same day with corresponding dollar amounts. Although certain examples have been used to illustrate alert data 164, any suitable data may be used.

In some embodiments, the database stores alert data 164 in a format that allows the data to be presented to a user 135 or administrator 150 in the form of a table of rows and columns. For example, the rows of alert data 164 may be organized according to transaction, attribute, or transaction type, and the columns may be organized according to descriptors describing the data. In some embodiments, the database presents a high-level view with hyperlinks to allow for drilling down into the details of a particular account or other information source.

FIG. 2B illustrates an example of customer profile 166. As described above, the database of server memory 160 may comprise one or more customer profiles 166. Customer profile 166 may comprise one or more customer identifiers 210. For example, customer identifiers may refer to the customer's first and last name 212, social security number 214, date of birth 216, unique party identifier 218 (e.g., global identifier across multiple accounts, like checking, savings, and loan), credit card account number 220, home loan account number 222, checking account number 224, or any other identifier that can identify the customer.

Customer profile 166 may also comprise customer type 230 (e.g., individual, large business, or small business), risk rating 240 (e.g., based on customer history, account balance, and type of potentially suspicious activity), one or more related party identifiers 250 (e.g., a related party identifier associated with members of the customer's household), and contact information 260 (e.g., home address, business address, or related party address). As an example, FIG. 2B illustrates a customer profile 166 for which the related party identifiers 250 include a spouse first and last name 252 and a child social security number 254, and contact information 260 includes residence phone number 262, business phone number 264, work email address 266, and/or residence address 268.

Although certain examples have been used to illustrate customer profile 166, any suitable data may be used. For example, in some embodiments, customer profile 166 may include information for each account associated with customer profile 166, such as the status of the account, the account balance, a description of the account, the jurisdiction where the account is domiciled, and so on. Further, the accounts may be linked to detailed account views. As another example, customer identifiers 210 may also include the customer's driver's license number, residence address, or primary contact information.

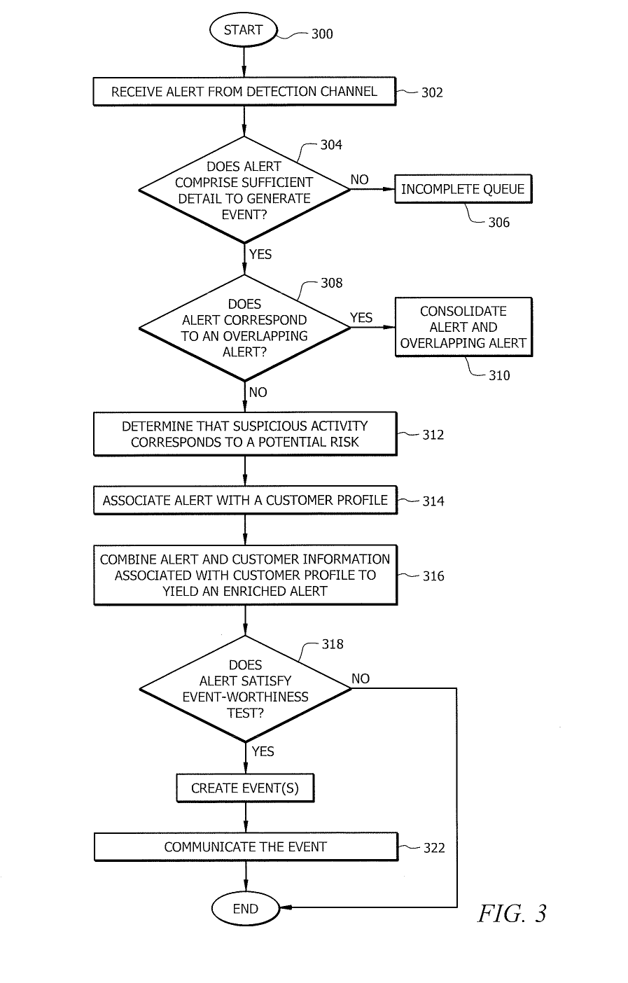

FIG. 3 illustrates a method flowchart 300 for analyzing an alert 190 to determine whether to create an event 195. The method begins at step 302 by receiving alert 190 from a detection channel 105. In some embodiments, detection channels 105 generate alerts 190 after detecting potential suspicious activity related to money laundering and other financial crimes. After generating alert 190, detection channels 105 communicate alert 190 to banks or other financial institutions.

In general, the method performs a validation of alert 190 at steps 304, 308, and 312. At step 304, the method determines whether alert 190 comprises sufficient detail to generate event 195 based on a series of validation rules. Checking for sufficient detail can include a completeness verification and/or a not-ready step.

A completeness verification may confirm whether alert 190 includes sufficient information to generate event 195. For example, an alert 190 may fail the completeness verification if the alert only comprises a location, dollar amount, and date, but does not include sufficient information to correlate the alert to a particular customer. Thus, alert 190 will need to be updated to further comprise a customer name, account number, or other suitable identifier before event 195 may be generated. In some embodiments, the method may flag alert 190 as incomplete in response to determining that alert 190 does not comprise sufficient information to generate event 195.

A not-ready step may determine alert 190 is not ready for downstream event processing based on specified alert attributes. As an example, the method may determine alert 190 is not ready for downstream event processing in response to receiving an attribute indicating a not-ready flag. As another example, the method may determine alert 190 is not ready for downstream event processing based on an attribute indicating the type of alert. That is, certain alerts 190 may be assigned to a type category used for piloting, debugging, testing, or other administrative purpose that may not require sending the alert 190 to downstream processes. In certain embodiments, the method may flag alert 190 if alert 190 is not ready for downstream processing and is not already flagged.

At step 306 of the illustrated embodiment, the method may communicate alert 190 to a queue, such as an incomplete queue, if alert 190 does not comprise sufficient detail. The method can automatically update alert 190 and send it back to step 304 or it can allow an administrator 150 to manually add details or make decisions concerning an incomplete alert 190 or a not-ready alert 190.

If alert 190 comprises sufficient detail to generate event 195, the method proceeds to step 308. At step 308, the method determines whether alert 190 corresponds to an overlapping alert based on the one or more financial transactions indicated by alert 190. For example, the method can check for a duplicate (e.g., total overlap) or for a partial overlap (e.g., when Transaction 1 triggers an alert based on dollar amount and Transaction 1 also triggers an overlapping alert based on location). If alert 190 corresponds to an overlapping alert, the method consolidates alert 190 and the overlapping alert at step 310.

At step 312, the method determines whether the potentially suspicious activity corresponds to a potential risk by performing a no-risk check. For example, if alert 190 indicates one or more financial transactions associated with a general ledger or concentration account used to move funds within, for example, an organization or business, but does not indicate specific customer activity being monitored by detection channels 105, alert 190 may not correspond to a potential risk. If alert 190 does not pose a potential risk, alert 190 may be communicated to a queue.

Alert 190 may be associated with a customer profile 166 at step 314. The method may associate alert 190 with customer profile 166 based on an attribute (e.g., an identifier associated with the customer that identifies the customer) of the one or more financial transactions indicated by alert 190. An attribute of a financial transaction can be a name, personal account number, business account number, and so on. In some embodiments, an attribute may be an identifier associated with members of the customer's household, such as a name or account number of the customer's spouse, children, and/or parents. Another attribute may be a unique party identifier. The party identifier may refer to a unique identifier assigned by the financial institution to identify the accounts that are to be included in customer profile 166. For example, the party identifier may be used to identify all of the accounts associated with the customer.

Once alert 190 is associated with customer profile 166, at step 316, the method enriches alert 190 and the customer information associated with customer profile 166 to yield an enriched alert. An enriched alert refers to data selected to provide a comprehensive view of alert 190 and may include alert data 164 and some or all of the customer information associated with customer profile 166. In some embodiments, enriching alert 190 can include determining an alert type, determining standard information recommended for that type of alert, determining if alert 190 contains the recommended information, and adding any of the customer's information that corresponds to the recommended information if it is not already included in alert data 164.

Examples of customer information that the method may add to alert 190 include a unique party identifier (for example, global identifier across multiple accounts, like checking, savings, and loan), a driver's license number, primary contact information (for example, home address, business address, or related party's address), personal account number and/or business account number, jurisdiction (where each account associated with the customer is domiciled), risk rating (for example, based on customer history, account balance, and type of potentially suspicious activity), or customer type (for example, individual, large business, or small business). In some embodiments, customer information added to alert 190 may also include a related party identifier associated with members of the customer's household, such as the customer's spouse, children, and/or parents. Moreover, enriching alert 190 can include associating alert 190 with an alert type, determining standardized fields for the alert type, and populating the standardized fields based on customer information in customer profile 166.

After enriching alert 190, the method processes the enriched alert data according to an event-worthiness test at step 318 to determine whether to generate event 195. An example of an event-worthiness test may be to determine whether the customer is an individual, a small business, or a large business, and whether the customer typically makes the type of financial transactions indicated in alert 190. For example, the method may determine that a large wire transfer is not event-worthy if it is made by a large company that typically makes large wire transfers. Upon a determination that the enriched alert is not event-worthy, the method ends without creating event 195. Alternatively, the method may determine that a large wire transfer is event-worthy if it is made by an individual customer that does not typically make large wire transfers. Once the method determines that the enriched alert is event-worthy, the method creates event 195 at step 320.

In some embodiments, the method may determine that alert 190 indicates a first transaction associated with a first jurisdiction and a second transaction associated with a second jurisdiction, and in response create a first event corresponding to the first jurisdiction and a second event corresponding to the second jurisdiction at step 320. An advantage of this embodiment would be simplified cases by creating events 195 that only include alert data 164 and customer information associated with customer profile 166 relevant to the event analysis teams and/or systems within a specific jurisdiction.

At step 322, the method communicates event 195. Event 195 may be communicated in any suitable format, including communicating event 195 in a standardized format comprised of standardized fields. For example, if a customer is an individual, the standardized fields may include a household identifier. But if the customer is a business, the standardized fields would not include a household identifier. Moreover, event 195 may be communicated to a display or other user interface, or it can be communicated to any downstream application (e.g., an event processing system).

In some embodiments, event 195 may be communicated as part of an event group and/or a case at step 322. As an example, the method at step 322 may associate a related party with event 195, associate the related party with a second event, and then group event 195 and the second event in an event group. The related party can be the customer itself, a member of the customer's household, or another related party. Additionally, the second event could be another potentially suspicious transaction by the same customer or by a member of the customer's household. For example, event 195 may be cash structuring transactions by the customer and the second event may be large cash deposits by the customer's spouse. At step 322, the method may group event 195 and the second event in an event group, and communicate the event group in any suitable format, as described above. As yet another example, the method may determine to open a case at step 322 if a risk-level causes a customer associated with event 195 to exceed a risk-points threshold. For example, the method may process event 195 according to a risk-determination rule to determine how many risk points to assign to event 195, including assigning risk points to each event in an event group, if any. If the number of risk points exceed a predetermined threshold, the method may generate a case. As an example of a risk-determination rule, the method may assign 2 points for cash structuring, 3 points for depositing large amounts of cash into an account, 5 points for multiple wires to multiple people on the same day with corresponding dollar amounts, and so on. The method may also assign a risk-points threshold of 5 points. Thus, the method may determine not to open a case for a single instance of cash structuring because the point value (2) is less than the risk-points threshold (5). By contrast, the method may open a case if event 195 or the event group includes an instance of depositing a large amount of cash into an account and an instance of multiple wires to multiple people on the same day with corresponding dollar amounts because the point values (3 and 5) collectively exceed the risk-points threshold (5+3>5).

Once the method communicates event 195, the event group, and/or the case at step 322, the method ends.

Modifications, additions, or omissions may be made to the systems described herein without departing from the scope of the invention. The components may be integrated or separated. Moreover, the operations may be performed by more, fewer, or other components. Additionally, the operations may be performed using any suitable logic comprising software, hardware, and/or other logic. As used in this document, “each” refers to each member of a set or each member of a subset of a set.

Modifications, additions, or omissions may be made to the methods described herein without departing from the scope of the invention. For example, the steps may be combined, modified, or deleted where appropriate, and additional steps may be added. Additionally, the steps may be performed in any suitable order without departing from the scope of the present disclosure.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system, comprising:
an interface operable to:
receive an alert, the alert indicating one or more financial transactions associated with potentially suspicious activity; and
one or more processors operable to:
perform a validation of the alert, the validation comprising:
determining that the alert comprises sufficient detail;
determining whether the alert corresponds to an overlapping alert based on the one or more financial transactions indicated by the alert and, if the alert corresponds to an overlapping alert, consolidating the alert and the overlapping alert; and
determining that the potentially suspicious activity corresponds to a potential risk;
associate the alert with a customer profile based on an attribute of the one or more financial transactions;
enrich the alert based on customer information associated with the customer profile to yield an enriched alert;
determine to create an event if the enriched alert satisfies an event-worthiness test; and
the interface further operable to:
communicate the event.

2. The system of claim 1, the one or more processors further operable to associate a related party with the alert.

3. The system of claim 1, the one or more processors further operable to determine attributes for the alert.

4. The system of claim 1, the one or more processors further operable to:
determine that the alert indicates a first transaction associated with a first jurisdiction and a second transaction associated with a second jurisdiction;
wherein the determining to create the event comprises determining to create a first event corresponding to the first jurisdiction and a second event corresponding to the second jurisdiction.

5. The system of claim 1, wherein the one or more processors is further operable to enrich the alert and customer information by:
associating the alert with an alert type;
determining standardized fields for the alert type; and
populating the standardized fields based on the customer information in the customer profile.

6. The system of claim 1, wherein the customer information comprises a unique party identifier.

7. The system of claim 1, the interface further operable to communicate the alert to an incomplete queue if the one or more processors determine that the alert lacks sufficient information based on a series of validation rules.

8. A non-transitory computer readable storage medium comprising logic, the logic, when executed by a processor, operable to:
receive an alert, the alert indicating one or more financial transactions associated with potentially suspicious activity;
perform a validation of the alert, the validation comprising:
determining that the alert comprises sufficient detail;
determining whether the alert corresponds to an overlapping alert based on the one or more financial transactions indicated by the alert and, if the alert corresponds to an overlapping alert, consolidating the alert and the overlapping alert; and
determining that the potentially suspicious activity corresponds to a potential risk;
associate the alert with a customer profile based on an attribute of the one or more financial transactions;
enrich the alert based on customer information associated with the customer profile to yield an enriched alert;
determine to create an event if the enriched alert satisfies an event-worthiness test; and
communicate the event.

9. The logic of claim 8, further operable to associate a related party with the alert.

10. The logic of claim 8, further operable to determine attributes for the alert.

11. The logic of claim 8, further operable to:
determine that the alert indicates a first transaction associated with a first jurisdiction and a second transaction associated with a second jurisdiction;
wherein the determining to create the event comprises determining to create a first event corresponding to the first jurisdiction and a second event corresponding to the second jurisdiction.

12. The logic of claim 8, wherein enriching the alert and customer information further comprises:
associating the alert with an alert type;
determining standardized fields for the alert type; and
populating the standardized fields based on the customer information in the customer profile.

13. The logic of claim 8, wherein the customer information comprises a unique party identifier.

14. The logic of claim 8, wherein performing the validation further comprises communicating the alert to an incomplete queue if the alert lacks sufficient information.

15. A method, comprising:
receiving an alert, the alert indicating one or more financial transactions associated with potentially suspicious activity;
performing, by a processor, a validation of the alert, the validation comprising:
determining that the alert comprises sufficient detail;
determining whether the alert corresponds to an overlapping alert based on the one or more financial transactions indicated by the alert and, if the alert corresponds to an overlapping alert, consolidating the alert and the overlapping alert; and
determining that the potentially suspicious activity corresponds to a potential risk;
associating the alert with a customer profile based on an attribute of the one or more financial transactions;
enriching the alert based on customer information associated with the customer profile to yield an enriched alert;
determining to create an event if the enriched alert satisfies an event-worthiness test; and
communicating the event.

16. The method of claim 15, further comprising associating a related party with the alert.

17. The method of claim 15, further comprising determining attributes for the alert.

18. The method of claim 15, further comprising:
determining that the alert indicates a first transaction associated with a first jurisdiction and a second transaction associated with a second jurisdiction;
wherein the determining to create the event comprises determining to create a first event corresponding to the first jurisdiction and a second event corresponding to the second jurisdiction.

19. The method of claim 15, wherein enriching the alert and customer information further comprises:
associating the alert with an alert type;
determining standardized fields for the alert type; and
populating the standardized fields based on the customer information in the customer profile.

20. The method of claim 15, wherein the customer information comprises a unique party identifier.
